(19) United States
(12) Patent Application Publication
(10) Pub. No.: US 2025/0184871 A1
(43) Pub. Date: Jun. 5, 2025

(54) CONFIGURING FOR COMMUNICATIONS WITH INTEGRATED ACCESS AND BACKHAUL NODES

(71) Applicant: ZTE CORPORATION, Shenzhen (CN)

(72) Inventors: Lin CHEN, Shenzhen (CN); Ying HUANG, Shenzhen (CN)

(73) Assignee: ZTE CORPORATION, Shenzhen (CN)

(21) Appl. No.: 19/042,574

(22) Filed: Jan. 31, 2025

Related U.S. Application Data
(63) Continuation of application No. PCT/CN2022/122002, filed on Sep. 28, 2022.

(51) Int. Cl. H04W 48/08; H04W 64/00

(52) U.S. Cl. CPC H04W 48/08; H04W 64/00

(57) ABSTRACT

Presented are systems, methods, apparatuses, or computer-readable media for transferring information in integrated access and backhaul (IAB) systems. A first wireless communication node may send configuration information to a network element. The configuration information may include at least one of: a mobile IAB indication, a mobile IAB prioritized indication, a mobile IAB-only indication, or an access related identity. The access related identity may include at least one of: a vehicle identifier, vehicle name, a physical cell identifier (PCI), a NR cell global identifier (NCGI), or a Network Identifier (NID).

This application claims the benefit of priority under 35 U.S.C. § 120 as a continuation of PCT Patent Application No. PCT/CN2022/122002, filed on Sep. 28, 2022, the disclosure of which is incorporated herein by reference in its entirety.

### TECHNICAL FIELD

The disclosure relates generally to wireless communications, including but not limited to systems and methods for configuring integrated access and backhaul (IAB) cells.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for transferring information in integrated access and backhaul (IAB) systems. A first wireless communication node may send configuration information to a network element. In some embodiments, the configuration information may include at least one of: a mobile IAB indication, a mobile IAB prioritized indication, a mobile IAB-only indication, or an access related identity. In some embodiments, the access related identity may include at least one of: a vehicle identifier, vehicle name, a physical cell identifier (PCI), NR cell global identifier (NCGI), or Network Identifier (NID). In some embodiments, the configuration information may include at least one of a closed access group (CAG) identifier or a human readable network name (HRNN), or a CAG-only indicator.

In some embodiments, the first wireless communication node may receive access-related information from a UE. In some embodiments, the first wireless communication node or a centralized unit (CU) connected with the first wireless communication node, may send, to a communication node, the access-related information to cause the communication node to send mobility restriction information. In some embodiments, the access-related information may include on-board UE indication, a CAG identifier, a vehicle identifier, or a network identifier. In some embodiments, the mobility restriction information may include at least one of a mobile IAB prioritized indication, a mobile IAB indication, a MR indication, a CAG identifier, CAG only indication, a vehicle identifier, or a network identifier.

In some embodiments, the first wireless communication node or a CU connected with the first wireless communication node may send access related information to a second wireless communication node or a CU connected with the second wireless communication node. In some embodiments, the access related information may include at least one of: a mobile IAB indication, a CAG identifier, a vehicle identifier, or a network identifier.

In some embodiments, the first wireless communication node or a CU connected with the first wireless communication node may receive access related information from an IAB node or a distributed unit (DU). In some embodiments, the access related information may include at least one of: a mobile IAB indication, a CAG identifier, a vehicle identifier, or a network identifier.

In some embodiments, the configuration information may include a mobility state information of the first wireless communication node. The mobility state may indicate one of a low state, a medium state, or a high state. In some embodiments, the configuration information may include a cell equivalent size for a cell.

In some embodiments, the configuration information may include at least one of: a PCI change indication, a NCGI change indication, a frequency change indication, a tracking area code (TAC) change indication, a radio access network-based notification area code (RANAC) change indication, or a cell configuration change indication. In some embodiments, the configuration information comprises at least one of: an old PCI, a new PCI, an old NCGI, a new NCGI, an old frequency, a new frequency, an old TAC, a new TAC, an old RANAC, or a new RANAC.

In some embodiments, the configuration information may include one or more thresholds for triggering intra/inter-frequency cell measurement. In some embodiments, the configuration information may include at least one of a measurement time duration or a reference signal received power (RSRP) jitter threshold.

In some embodiments, the first wireless communication node may receive, from a second communication node, a paging message comprising the configuration information. In some embodiments, the configuration message may include at least one of: mobile IAB indication, CAG ID, vehicle ID, NID, a list of identifiers identifying one or more cells which the UE is permitted to access, or an indication which indicates whether the UE is allowed to access non-mobile IAB cells. In some embodiments, the first wireless communication node may receive, from a UE, cell information comprising at least one of a mobile IAB indication, a CAG identifier, a vehicle identifier, a NID of at least one cell.

In some embodiments, the first wireless communication node or a CU connected with the first wireless communication node may send DU configuration information to a second wireless communication node or a CU connected with the second wireless communication node. The DU configuration information comprises at least one of a PCI, a NCGI, or a TAC, or RACH configuration. In some embodiments, the second wireless communication node or the CU connected with the second wireless communication node may send DU configuration information to the first wireless communication node or the CU connected with the first wireless communication node.

In some embodiments, the first wireless communication node or the CU connected with the first wireless communication node may send updated DU configuration information to the first wireless communication node or the CU connected with the first wireless communication node. In some embodiments, the updated DU configuration information may include at least one of: an old PCI, a new PCI, an old NCGI, a new NCGI, an old TAC, a new TAC, random access channel (RACH) configuration, a timer, or a mobile IAB indication, or a mobile IAB cause value. In some embodiments, the network element may send the number of requested NCGIs to the first wireless communication node. In some embodiments, the configuration information may include a set of NCGIs to be added or released.

In some embodiments, the first wireless communication node or a CU connected with the first wireless communication node may send, to a communication node, user location related information. In some embodiments, the user location related information may include at least one of: a cell identity, a tracking area identity (TAI), a public land mobile network (PLMN) identity, a tracking area code (TAC), or cell information of a cell of a co-located DU. In some embodiments, the cell information may include at least one of a second cell identity, a second TAI, a second PLMN ID, or a second TAC.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram an integrated access and backhaul (IAB) architecture network in which a core network is connected to a donor IAB node, in accordance with an illustrative embodiment;

FIG. 4 illustrates a block diagram of a scenario of a mobile IAB node, in accordance with an illustrative embodiment;

FIG. 5 illustrates a flow diagram of a method of transferring configuration information in integrated access and backhaul (IAB) systems in accordance with an illustrative embodiment; and

FIG. 6 illustrates a flow diagram of a method of facilitating handovers in integrated access and backhaul (IAB) systems in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

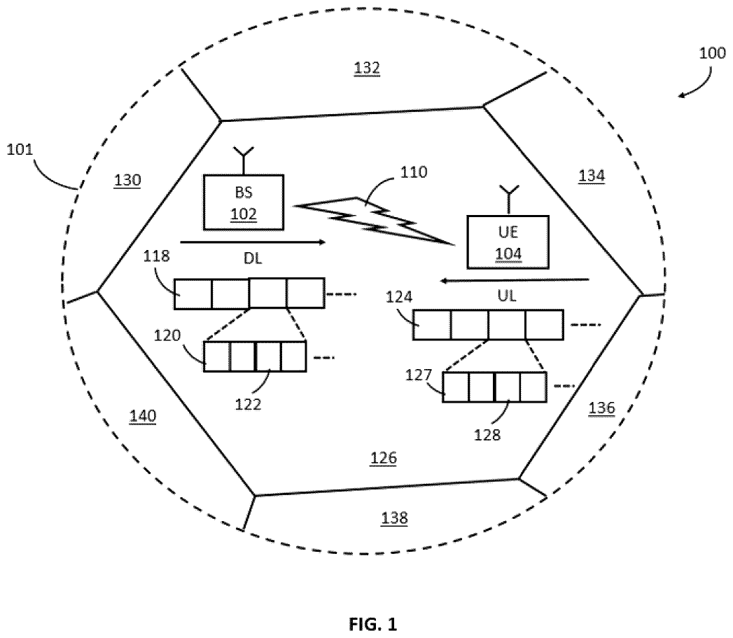

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

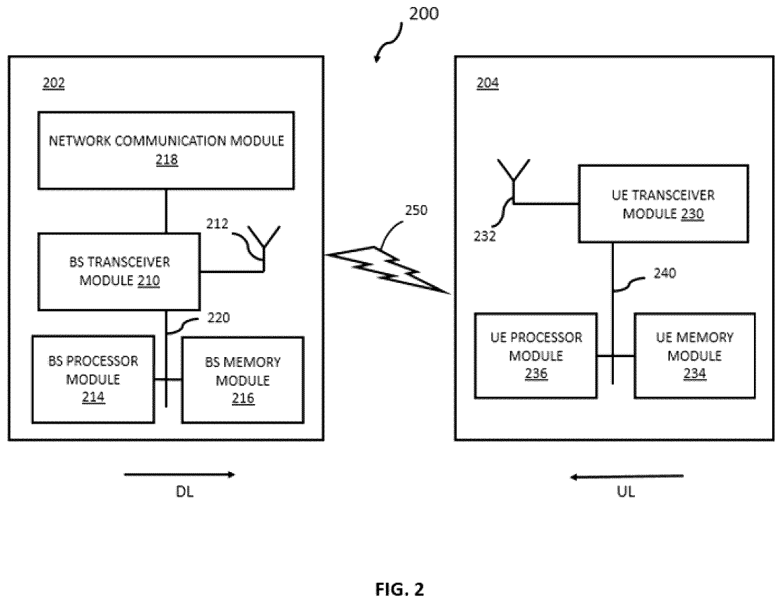

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Configuring Integrated Access and Backhaul (IAB) Cells

As the number of applications and services for digital data continues to increase, the demands and challenges placed on network resources and operators may also continue to increase. Being able to deliver a wide variety of network performance characteristics that future services will demand may be one of the primary technical challenges faced by service providers. The performance requirements placed on the network may demand connectivity in terms of data rate, latency, quality of service (QOS), security, availability, and many other parameters, all of which may vary from one service to the next. Thus, enabling a network to allocate resources in a flexible manner to provide customized connectivity for each different type of service may greatly enhance the network's ability to meet future demands.

To meet such demands, 5th Generation (5G) mobile wireless technologies and standards may be leveraged. One such technology may be a split network architecture wherein a radio access network (RAN) functionality is split between a central unit (CU) and multiple distributed units (DUs). For example, RAN functions may be split at the point between the Packet Data Convergence Protocol (PDCP) layer and the Radio Link Control (RLC) layer of the 5G protocol stack. In the stack, DUs may handle all processes up to and including the RLC layer functions and the CU may handle PDCP layer and higher layer functions prior to the core network. This disaggregation of RAN functions may provide numerous advantageous to mobile network operators. For example, through the isolation of the stack from the PDCP layer and upwards, the CU may act as a cloud-based convergence point among multiple heterogeneous technologies in the provisioned networks and hence will be able to serve multiple heterogeneous DUs.

Another technology being developed for 5G networks may be the Integrated Access and Backhaul (IAB) architecture for providing high-speed wireless backhaul to cell sites (e.g., base stations). As data demands and the number of cell sites increase, it may be more difficult to provide fiber optic backhaul access to each cell site, especially for small cell base stations. Under the IAB architecture, the same infrastructure and resources (e.g., IAB nodes) can be used to provide both access and backhaul to support User Equipment (UE) Packet Data Unit (PDU) sessions. The IAB architecture for New Radio (NR) networks may provide wireless backhaul and relay links enabling flexible and dense deployment of NR cells without the need for densifying the transport network proportionately. Additionally, IAB technologies may allow for easier deployment of a dense network of self-backhauled NR cells in a more integrated and robust manner. For example, the IAB technology in the 5G NR network may support a multi-hop relay system, where the network topology also can support redundant connections.

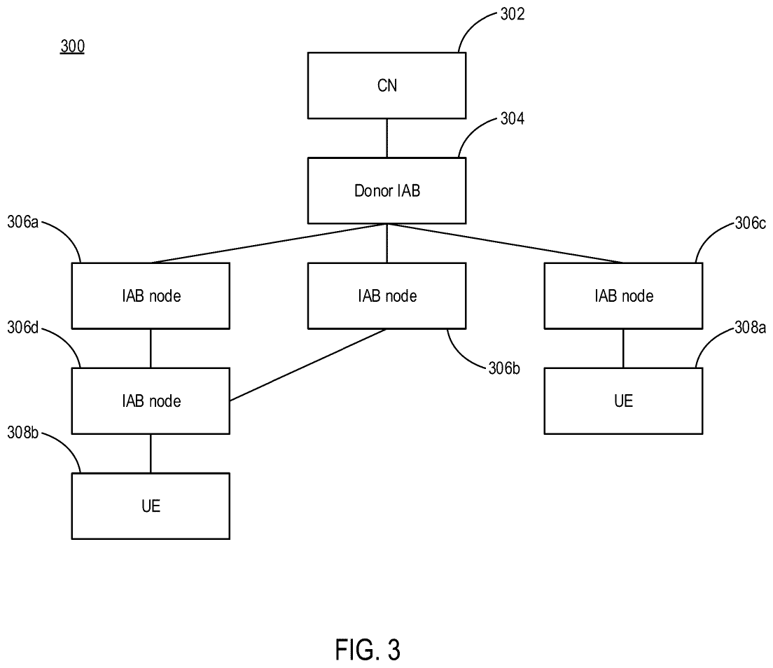

Referring now to FIG. 3, depicted is a block diagram of an IAB architecture network 300 wherein a core network 302 is connected to a donor IAB node 304. The connection may be a wired or cabled connection (e.g., a fiber optic cable) between two nodes or devices. The donor IAB node 304 may be wirelessly coupled to a plurality of intermediate IAB nodes 306a and 306b and two serving IAB nodes 306c and 306d. The coupling may be direct or indirect and wired or wireless communications between two nodes or devices.

As shown, serving IAB nodes 306c and 306d may be directly coupled to UEs 308a and 308b, respectively, and function as the serving cell site base stations or access points for the UEs 308a and 308b. The UEs 308a and 308b may be referred to herein as “access UEs.” The serving IAB nodes 306c and 306d may also function as relay and can forward their respective UE signals to their respective next uplink nodes in the transmission path, and forward downlink signals to their respective UEs 308a and 308b. The serving IAB node 306c can forward uplink UE signals to one or both of the intermediate IAB nodes 306a and 306b, and receive downlink UE signals from one or both of the intermediate IAB nodes 306a and 306b. The intermediate IAB nodes 306a and 306b can forward uplink UE signals to the donor IAB node 304, and forward downlink signals to the serving IAB node 306d. The serving IAB node 306c can forward uplink UE signals to the donor IAB node 304, which can then forward all received signals to the core network 302, and can forward downlink signals from the donor IAB node 304 to the access UE 308a.

Each of the IAB nodes 306a-306d can have two functions: a base station (BS) function and a mobile terminal (MT) function. The BS function may correspond to the IAB node function as if a base station to provide the radio access function for a UE. The BS part of an IAB node can refer to the corresponding portion of the IAB node, including all hardware, firmware or software related to performing the BS functions of the IAB node. The MT function can refer to the IAB node functioning as if a mobile terminal to be controlled and scheduled by the IAB donor node or an upper IAB node. The MT part of an IAB node can refer to the corresponding portion of the IAB node, including all hardware, firmware or software related to performing the MT functions of the IAB node.

If the network 300 also implements a split architecture, the donor IAB node 304 can be replaced by a donor CU (not shown) connected to the core network 302 and a donor DU (not shown) connected to the donor CU. Each of the IAB nodes 306a-306d would be coupled to the donor DU in similar fashion to their coupling to the donor IAB node 304, as shown.

In a split architecture network, each of the IAB nodes 306a-306d can have two functions: a DU function and a mobile terminal (MT) function. The DU function can refer to the IAB node functioning as if a DU to provide the predetermined DU functions for a UE. The DU part of an IAB node can refer to the corresponding portion of the IAB node, including all hardware, firmware or software related to performing the DU functions of the IAB node. The MT function and MT part of an IAB node in a split architecture network may be the same as described above for a non-split architecture network.

Based on the IAB architecture, the mobile IAB which focus on the scenario of mobile-IAB-nodes mounted on vehicles providing 5G coverage and capacity enhancement to onboard or surrounding UEs is presented herein. To be specific, the mobile IAB can be used in outdoor environment to improve 5G coverage or connectivity, following a certain known or predictable itinerary (e.g. buses, trams, etc.), or situated in convenient locations (e.g. outside stadiums, hot-spot areas, or emergency sites). The mobile IAB node may provide connectivity for users or devices inside the vehicle itself and use 5G wireless backhaul toward the macro network. The mobile IAB may be assumed to obtain better macro coverage than a nearby UE, e.g. exploiting better RF or antenna and power capabilities.

The implementation of the mobile IAB in the 5G network can raise many challenges, such as how to reduce the cell reselection of UEs camped on the mobile IAB cells and keep the UE camped on the mobile IAB cell, how to reduce the potential interference caused by a physical cell identifier (PCI) or a random access channel (RACH) collision due to the mobility of mobile IAB node.

For the cellular system, RRC_IDLE state may be used for power saving purpose. Generally speaking, the gNB broadcast a tracking area code (tracking area code) for each subset of public land mobile networks (PLMNs) within a cell. Generally speaking, the TAC broadcast by gNB may be configured by operations, administration, and maintenance (OAM) and the corresponding tracking area may be Earth-stationary. gNB can send the supported a tracking area identity (TAI) (e.g., PLMN ID and TAC) list info of serving cell to the access and mobility management function (AMF). Based on this info, AMF can be aware the tracking area of each cell. For the UE, the UE may be configured a list of TAI (e.g., registration area) from AMF when the UE was in RRC_Connected state. The AMF may take the TAI where the UE is geographically located into account to generate a suitable Registration Area for the UE.

When the UE enters RRC_IDLE state, the UE may not have to perform a handover (HO) when the UE moves across different cells. Instead, the RRC_IDLE UE may perform periodic registration area update (RAU, which may also be called as tracking area update (TAU)) for UE reachability tracking and event-triggered RAU for UE registration area tracking. For example, the update may be performed, when accessing a radio cell where none of the supported TACs for the RPLMN or equivalent to the RPLMN are part of the UE Registration Area. On the other hand, when the downlink (DL) data for RRC_IDLE UE arrived, the AMF may send paging message to all the gNBs involved in the registration area of this UE. Upon receiving the paging message from AMF, gNB can determine which cell should be involved for the paging based on the TAI information. When the RRC_IDLE UE receive the paging message, the RRC_IDLE may enter RRC_Connected state and be ready for the DL data reception.

On the other hand, the RRC_INACTIVE state may also be used for power saving purposes. The RRC_INACTIVE UE may be configured by the last serving gNB with an radio access network (RAN) notification area (RNA). The RNA can cover one or multiple cells, and may be a subset of or equal to a core network (CN) Tracking Area. To be specific, the RNA may be configured via a list of cells or a list of RAN Area Code (RNAC) or TAC. On the other hand, a cell can broadcast one RAN area code in a system information block (e.g., SIB1). Generally speaking, this RAN area code can be configured by OAM.

A RAN-based Notification Area Update (RNAU) may be periodically sent by the UE and may also be sent when the cell reselection procedure of the UE selects a cell that does not belong to the configured RNA. When UE performs RNAU, the UE may send the RRCResumeRequest to gNB, providing an inactive radio network temporary identifier (I-RNTI) allocated by the last serving gNB and appropriate cause value (e.g., RAN notification area update). If gNB is able to resolve the gNB identity contained in the I-RNTI, the gNB may request the last serving gNB to provide UE Context. Finally, the UE may resume from RRC_INACTIVE to RRC_Connected/RRC_IDLE state or return back to RRC_INACTIVE state. Moreover, a RAN paging may be triggered due to incoming DL user plane, DL signaling from 5GC, etc. In this case, the RAN paging may be triggered in the cells controlled by the last serving gNB. In addition, the RAN paging may be triggered by means of Xn RAN Paging in cells controlled by other gNBs, configured to the UE in the RNA. If UE receives the paging with the I-RNTI of itself, the UE may attempt to resume from RRC_INACTIVE to RRC_CONNECTED.

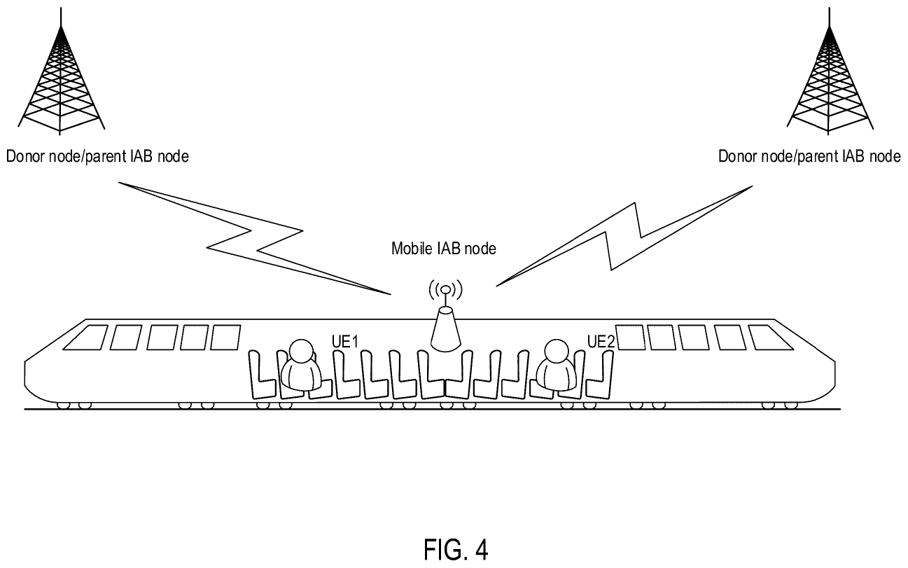

Referring now to FIG. 4, depicted is a block diagram of a scenario of a mobile IAB node. For the mobile IAB scenario, the mobile IAB node moves together with the vehicles, which may be across different registration areas, as shown. The RAU in mobile IAB scenario may deal with a large group of UEs and should be kept to minimum level. On the other hand, the UE reachability should be ensured. Similar to RAU, the RNAU in mobile IAB scenario may also involve a large group of UEs and should be avoided. Similar to RAU, the RNAU in mobile IAB scenario may also involve a large group of UEs and should be avoided. On the other hand, the UE reachability should be ensured. Presented herein are systems and methods to address these issues.

### A. Access Control

The mobile IAB node may allow the access of an on-board UE, which should be authorized or subscribed to the specific mobile IAB cell or based on manual selection. In this case, the following solutions can be considered.

### I. Mobile Indications:

The UE may be able to know that the UE itself is allowed to access the mobile relay (MR) or mobile IAB node on a specific vehicle. This awareness can be achieved via a non-access stratum (NAS) layer or an application (APP) layer. In addition, the UE may be configured with access related configuration information, such as from gNB, gNB-CU, gNB-DU, or an access and mobility management function (AMF).

The access-related configuration information may include one or more of the following. The information may include a mobile IAB indication, a MR indication, or a MR-prioritized indication. The indication may indicate the UE can prioritize the cell of the IAB node, mobile IAB node, or mobile relay (e.g., for cell selection, cell re-selection, or handover). The information may include an MR-only indication indicating that the UE is only allowed to access, select, re-select, or perform handover to the cells of IAB node, mobile IAB node, or the mobile relay, among others. The information may include one or more identities, such as: a vehicle identifier, a physical cell identifier (PCI), a NR cell global identity (NCGI), a network identifier (NID), or vehicle name similar to a human-readable network name (HRNN), among others. When the UE detects the vehicle identifier, PCI, NGCI, or vehicle name broadcast by a cell matching the configured identity, the UE may prioritize to select, re-select, or handover to this cell.

In addition, the mobile IAB node cans send at least one of the following to UE (e.g. via broadcasting: a mobile IAB indication and an identity, such as a vehicle identifier, a PCI, a NGCI, or a vehicle name similar to a HRNN, among others.

### II. Closed Access Groups (CAG)

A closed access group (CAG) of a public network integrated non-public network (PNI-NPN) may be leveraged for the access control of mobile IAB. To be specific, the CAG can identify a group of UEs that are permitted to access one or more CAG cells associated to the CAG. Similar to PNI-NPN, a CAG identifier (CAG ID) and HRNN can be broadcast in system information of mobile IAB node. For the UEs (e.g. on-board UEs), the UEs may be configured with one or more CAG identifiers which the UE is allowed to access. In addition, the UE (e.g., on-board UE) may be configured with a CAG-only indication if the UE is only allowed to access CAG cells.

For example, when the UE get onboard, the UE may negotiate via APP layer to indicate the UE's presence and the UE may be then configured with the one or more CAG identifiers or CAG-only indication. On the other hand, when the UE leaves the vehicle or the serving time of the UE has expired, the UE may be reconfigured to remove the CAG identifier or CAG only indication. Afterwards, the UE can be served by non-mobile IAB cells. The HRNN can be provided by the SIB for the manual selection of CAG cells of the MR.

### III. Mobility Restriction Information

First, when a UE access a MR cell, UE may send access-related information to the gNB or CU. The access related information can include at least one of the following: an on-board UE indication, a CAG identifier, a vehicle identifier, and a network identifier, among others.

Second, the gNB can forward or send the access related information to the AMF. Third, the AMF can check whether the UE is allowed to access the cell. If allowed, the AMF can set up a NG connection and can provide the gNB with the mobility restrictions information applicable for the MR access. If not allowed, the AMF may reject the UE. The mobility restrictions information may include at least one of the following: a CAG identifier, a vehicle identifier, a network identifier, a CAG only indication, a MR indication, and a mobile IAB indication, among others.

Fourth, the gNB can receive the mobility restrictions information. When UE is to perform HO, the gNB may select the neighboring cells which support the corresponding CAG identifier, vehicle identifier, or NID. To support this, the gNB can send mobile IAB indication or the support CAG identifier, vehicle identifier, NID of its cell to neighboring gNB.

For the split gNB architecture, IAB node may be configured configure with a list of CAG identifier, vehicle identifiers, or NIDs via OAM. The IAB node may send the configured CAG, vehicle identifier, or the NID of its cell to the gNB-CU.

### B. Cell Selection & Re-Selection

### I. Mobile Relay Priority

For the cell selection or reselection, the UE may prioritize to select the mobile IAB cells if the UE is MR capable. If the UE is configured with one or more vehicle ID, NCGI, mobile IAB indication, HRNN, NID, CAG ID or the mobile relay priority is enabled, the UE can prioritize selection of the cells with matched vehicle ID, NCGI, mobile IAB indication, MR HRNN, NID, and MR CAG ID.

In some embodiments, if the UE is a MR capable UE, the UE may consider the frequency providing MR service to be the highest priority. On the other hand, if the UE is not configured with vehicle ID, NCGI, mobile IAB indication, HRNN, NID, CAG ID or the mobile relay priority is disabled, UE can de-prioritize selection of the cells with corresponding vehicle ID, mobile IAB indication, NID, MR HRNN, or MR CAG ID.

### II. Low Mobility State Indication

The mobile IAB cells may broadcast the high, medium, low mobility state indication. The UE can also check whether the UE is in high, medium or low mobility state. If the mobility state of UE matches the mobile IAB cell, the UE can prioritize selection of the corresponding mobile IAB cell. Otherwise, the UE may deprioritize the selection of corresponding cell. Once the UE is camped on the mobile IAB cell, the UE may keep camped on this cell since they are relatively stationary. In this case, mobile IAB cell can broadcast the cellEquivalentSize (e.g., a number of cell count used for mobility state estimation for this cell) which may assist the UE to determine its mobility state (e.g. high, medium, or low).

### III. Notification of Changes

During the movement of mobile IAB, the PCI, NCGI, or frequency of mobile IAB cells may change. From the perspective of a UE in RRC_IDLE/INACTIVE state, the UE may no longer detect the serving cell and then initiate the intra/inter-frequency measurement after the UE has evaluated in Nserv consecutive DRX cycles (e.g., more than 10 s) that the serving cell does not fulfil the cell selection criterion S. Based on this observation, it may be better that UE is notified with the PCI, NCGI, frequency, TAC, or RNAC change in advance.

The UE may receive at least one of the following information from gNB or IAB-DU: a PCI change indication, NCGI change indication, frequency change indication, TAC change indication, RNAC change indication, cell configuration change indication, old PCI, new PCI, old NCGI, new NCGI, old frequency, new frequency, old TAC, new TAC, old RNAC, new RNAC. The camped UE in the RRC_IDLE/INACTIVE state can try to select the cell with new PCI, frequency, or NCGI.

On the other hand, if the UE is not notified of the new PCI, the UE may continue to be camped on the cell with the old PCI. The old PCI may be used by the neighboring stationary cells, which may cause confusion for the UE in the RRC_IDLE or INACTIVE state. Since the SIB is different, the neighboring cell with old PCI may belong to different PLMN and should not be selected. If the mobile IAB cell notifies the PCI, NCGI, frequency, TAC, or RNAC change to UE via system information, the UE may perform the intra/inter-frequency measurement with the stored information. Once UE detects the cell with the specific PCI or frequency, the UE may select it. Moreover, the UE may or may not check the S criteria of a cell using parameter values stored previously.

IV. Thresholds for Measurements of Frequencies with Priority

For the on-board UE which has already camped on MR cells, in order to avoid unnecessary inter-frequency measurement with high priority, the UE may regard the frequency which provide mobile IAB cell to be the highest priority. In addition, the UE may perform intra-frequency measurement if one of the following two conditions cannot be met: (1) the serving cell fulfils Srxlev>SIntraSearchP or (2) Squal>SIntraSearchQ. Furthermore, the UE may perform measurements of lower priority NR inter-frequency or inter-RAT frequencies than the reselection priority of the current NR frequency if one of the following two conditions cannot be met: (1) If the serving cell fulfils Srxlev>SnonIntraSearchP and (2) Squal>SnonIntraSearchQ. On top of that, if the UE is of low mobility with current serving cell, the UE may perform relaxed radio resource management (RRM) measurements for intra-frequency or inter-frequency cells.

The low mobility may be detected via the reference signal received power (RSRP) measurement. The variation between current RSRP measurement result and the maximum RSRP for the time period for which the variation is evaluated may be lower than a given threshold. In this case, the low mobility criteria may be met and the UE may perform relaxed measurement. Furthermore, the UE may be configured with new threshold for SIntraSearchP/SnonIntraSearchP and SIntraSearchQ/SnonIntraSearchQ, which is lower than the normal threshold for SIntraSearchP/SnonIntraSearchP and SIntraSearchQ/SnonIntraSearchQ. The new threshold can further slow the intra or inter-frequency cell measurement for cell re-selection.

On the other hand, if the on-board UE moves off the vehicle, the UE may detect that the serving cell no longer fulfils: (1) Srxlev>SIntraSearchP or (2) Squal>SIntraSearchQ. In this case, the UE may perform the intra or inter-frequency measurement and reselect other cells. If the UE is aware that the UE is no longer on-board, the UE may no longer prioritize the mobile IAB cells or corresponding frequency for cell reselection.

### V. Thresholds for Measurements of Neighboring Cells

To minimize the measurement of neighboring cells, UE prioritize the mobile IAB cells if they have similar mobility speed/state. Specifically, when UE determines that the variance of RSRP measurements of MR cells for a given time duration is lower than a jitter threshold and the RSRP measurement of MR cell is above a given threshold, the UE may consider that it is in a similar speed or trajectory with MR cell and thus prioritize the selection of MR cells. In order to support that, UE needs to be configured with the measurement time duration and/or RSRP jitter threshold, e.g. from gNB or IAB-DU.

### C. Paging

The gNB receives a paging message (e.g. from AMF) including at least one of the following: mobile IAB allowed/enabled/prioritized indication, a list of CAG ID/vehicle ID/NID allowed for the UE, an indication which indicates whether the UE is allowed to access non-mobile IAB cells. The NG-RAN node may use this information to avoid paging in cells on which the UE is not allowed to camp.

For UEs in RRC_INACTIVE state, gNB may send a paging message to a neighbor gNB. The paging message includes at least one of the following: mobile IAB allowed/enabled/prioritized indication, a list of CAG ID/vehicle ID/NID allowed for the UE, an indication which indicates whether the UE is allowed to access non-mobile IAB cells. The neighbor gNB node may use this information to avoid paging in cells on which the UE is not allowed to camp.

### D. Automatic Neighbor Relationship (ANR)

The ANR function may reside in the gNB and manages the Neighbor Cell Relation Table (NCRT). Located within ANR, the Neighbor Detection Function may find new neighbors and add the new neighbors to the NCRT. The ANR may also contain the Neighbor Removal Function which removes outdated neighbor cell relations (NCRs). In general, the NCR may contain a list of entries for each source cell which include the NR CGI or NR PCI of target cell and attributes such as Xn availability and handover, among others.

The gNB may obtain the NCR information via OAM configuration, neighbor information exchange via Xn setup or gNB Configuration Update procedure. In addition, gNB may request UE to use the newly discovered PCI as parameter and to read all the broadcast NCGI(s), Evolved Universal Terrestrial Radio Access cell global identities (ECGI(s)), TAC(s), RANAC(s), PLMN ID(s) and, for neighbor NR cells, NR frequency band(s), among others. The UE may report these information of neighboring NR cells to the gNB The gNB may decide to add this neighbor relation to NCRT. In addition, the gNB may use PCI and NCGI(s) to lookup a transport layer address to the new NG-RAN node and setup a new Xn interface towards this NG-RAN node.

For the mobile IAB scenario, the mobile IAB node may send the cells information to donor CU via F1 interface, once the mobile IAB node MT has connected or handover to donor CU. This donor CU may then notify the neighbor gNB with the updated served cell info via Xn interface. For the other neighbor gNB which has no Xn interface with donor CU, the UE may detect the PCI of mobile IAB cells and report to the neighbor gNB. It may not be recommended for the neighboring UE served by non-mobile neighboring cells to perform a handover to the mobile IAB cells. As such, the cells of mobile IAB node may not be added to the neighboring gNB's NCRT. One issue may entail how to prevent the gNB to add the cells of mobile IAB node to the neighboring gNB's NCRT.

The UE may send the mobile IAB indication, CAG ID, vehicle ID, or NID of mobile IAB cells to gNB or gNB-CU, together with other NCGI(s), ECGI(s), TAC(s), RANAC(s), PLMN ID(s), and NR frequency band(s) information. Based on this information, the gNB may decide not to add the entry for mobile IAB cells into the NCRT.

### E. Random Access Channel (RACH)-Less Handover

A target eNB may decide whether a RACH may be skipped for a UE during handover (HO) preparation phase. If UE receives the HO command with RACH-skipped indication, the UE may not perform RACH. Instead, the UE may access the target cell via the timing adjustment indication and optionally the uplink grant pre-allocated to the UE. If the pre-allocated uplink grant is not included, the UE may monitor PDCCH of the target eNB to receive an uplink grant. The issue may involve how to support RACH-less HO in mobile IAB scenario.

With a mobile IAB scenario, an on-board UE may be kept connected with the mobile IAB-cells. Even if the intra-cell HO is performed due to donor CU change or PCI change, the UE may utilize the RACH-less HO. To support this, the UE may be notified with RACH-skipped indication via the RRCReconfiguration with sync. In order to reduce the impact, the UE may identify that RACH can be skipped if the PCI or NCGI of source and target cell does not change or the PCI/NCGI mapping between source and target cell is configured via HO command.

### F. Physical Cell Identifier (PCI) Optimization

The OAM may assign a single PCI for each NR cell in the gNB, and the gNB may select this value as the PCI of the NR cell. In addition, the OAM may assign a list of PCIs for each NR cell in the gNB, and the gNB may select a PCI value from the list of PCIs. The gNB may restrict this list by removing some potential collided PCIs that are reported by UEs, reported over the Xn interface by neighboring gNBs, or acquired through other method (e.g., detected over the air using a downlink receiver).

With regard to the split gNB architecture, the OAM may configure a PCI for each NR cell to the gNB-DU. The gNB-DU may report this to gNB-CU. If the gNB-CU detects PCI conflict of NR cells, the gNB-CU may report the NR cells suffering PCI conflict to OAM directly. The OAM may be in charge of reassigning a new PCI for the NR cell subject to PCI conflict. On the other hand, the OAM may assign a list of PCIs for each NR cell and may send the configured PCI list to the gNB-CU. If the gNB-CU detects PCI conflict, the gNB-CU may select a new PCI value from the preconfigured PCI list for the NR cell. The gNB-CU may send the new PCI value to the gNB-DU by F1 Setup procedure or gNB-CU configuration update procedure.

For the mobile IAB scenario, if centralized PCI assignment is used, the PCI for mobile IAB node may be assigned by OAM. It may be possible that the PCI for mobile IAB node may be especially reserved and not conflict with other neighboring non-mobile cells. However, if this PCI for mobile IAB cells does conflict with neighboring cells during the movement, the donor CU may report this mobile IAB cells suffering PCI conflict to the OAM directly and the OAM may reassign a new PCI for the mobile IAB cells. In some embodiments, if the donor-CU is configured with a PCI list and the donor CU detects PCI conflict, the donor CU may select a new PCI value from the preconfigured PCI list for the NR cell and send it to the mobile-IAB-DU.

Based on the legacy procedure, the donor CU may be aware of the PCI via the F1 Setup procedure or gNB-DU configuration update procedure after the mobile IAB-MT HO and during the mobile IAB DU migration. In order to reduce the impact of PCI conflict, the mobile IAB node may receive the re-assigned PCI as early as possible.

The configuration of mobile IAB DU's cells may be sent by source donor CU to the target donor CU during the HO preparation phase of mobile IAB node. The configuration of mobile IAB DU's cells may include at least one of: a PCI, a NCGI, or a TAC, among others. The target donor CU may re-assign configurations for the mobile IAB DU's cells via the RRCReconfiguration message of mobile IAB-MT. The configuration may be reassigned using a mapping between: old PCI and new PCI; old NCGI and new NCGI; and old TAC and new TAC, among others. The reassignment may be performed, for example, if the target donor CU receives the PCI of mobile IAB DU's cells and detect potential PCI conflict.

The target donor CU may send the reassigned configurations to source donor CU. Upon receiving the RRCReconfiguration with sync message from source donor CU, the mobile IAB-MT may deliver the PCI, NCGI, TAC configuration of mobile IAB cells to the mobile IAB DU. The IAB-DU may then broadcast the update of PCI, NCGI, or the TAC via system information. After a system information notification period, the mobile IAB-DU may update the PCI, NCGI, or TAC correspondingly.

### G. Random Access Channel (RACH)-Less Configuration Collision

The RACH optimization may be supported (e.g., in accordance with legacy specification) by UE reported information, such as: contention detection indication per RACH attempt, indexes of synchronization signal blocks (SSBs), and number of RACH preambles sent on each tried SSB listed in chronological order of attempts, indication whether the selected SSB is above or below the RSRP-ThresholdSSB threshold per RACH attempt. The information may be made available at the NG RAN node and by physical random access channel (PRACH) parameters exchange between NG RAN nodes.

In case of split gNB architecture, the RACH configuration conflict detection and resolution function may be located at the gNB-DU. The gNB-CU may send the RACH report reported by the UE to gNB-DU via F1AP signaling. The gNB-DU may signal the PRACH configuration per-cell to gNB-CU. The gNB-CU may forward a limited set of neighbor cell's PRACH configurations received from neighbor gNB-CU to the gNB-DU to resolve the configuration conflict.

From this, the issue may be how to resolve the RACH configuration collision issue in mobile IAB scenario. With a mobile IAB scenario, the RACH configuration of mobile IAB-DU's cell may conflict with the neighboring non-mobile IAB cells. It may likely to reuse the existing approach to resolve the RACH configuration collision.

### I. Providing Updated RACH Configurations

A mobile IAB-DU may change the RACH configuration: During the HO preparation phase for mobile IAB-MT, the source donor CU may send the RACH configuration of mobile IAB-DU to target donor CU. The target donor CU may send the updated RACH configuration of mobile IAB-DU to mobile IAB-MT via the RRCReconfiguration with sync. In some embodiments, the target donor CU may send the RACH configuration of its served cells and neighboring cells to mobile IAB-MT via the RRCReconfiguration with sync. Upon receiving such configuration, the co-located mobile IAB-DU may use the updated RACH configuration or adjust the RACH configuration based on the RACH configuration of target donor CU's served cells and neighboring cells.

### II. Providing RACH Configuration of Served Cell

Neighboring cells may change the RACH configuration: After the mobile IAB-MT handover to the target donor CU, the co-located mobile IAB-DU may set up the F1 connection with the target donor CU. During this procedure, the mobile IAB-DU may send the RACH configuration of its served cell to target donor CU. Target donor CU may then send the RACH configuration of the cells of mobile IAB-DU to other served cells of donor CU and neighboring cells together with a timer and mobile IAB cause value. The sending of the timer and the mobile IAB cause value may trigger the served cells of donor CU and neighboring cells which may have RACH conflict not to use the conflict resource for the given time defined by the timer.

### H. Identifier Collisions

For the mobile IAB scenario, the mobile IAB node may move with the vehicle and thus may connect to different donor nodes. The problem may be how to configure cells of mobile IAB during the movement, such as NCGI, TAC, RACH resource configuration.

When the mobile IAB-node-MT initially connects to the network, the donor CU may be aware that the IAB-node-MT is actually a mobile IAB based on the mobile IAB authorized information element (IE) received from AMF. Then the donor CU may assign a set of NCGIs to the mobile IAB-node-MT via the RRCReconfiguration message. The mobile IAB-node-MT may use these NCGIs for the served cells of the co-located mobile IAB-node-DU. Moreover, the mobile IAB-node-MT may send the number of NCGIs required to the donor CU and then the donor CU may assign corresponding number of NCGIs to the mobile IAB-node-MT. Considering that the number of served cells of mobile IAB-node-DU may change, the mobile IAB-node-MT may send the updated number of required NCGIs to donor CU. The donor CU may send the NCGI to be add or to be release configuration to mobile IAB-node-MT.

### I. User Location Related Information

In mobile IAB scenario, the mobile IAB node may move along with the vehicle. In this case, the user location information (ULI) (e.g. cell ID or TAC) of the UE sent by gNB-CU to the AMF may not always accurately reflect the location of the UE. This may affect services, such as regulatory services and tariff notifications, among others, which rely on cell ID and TAC as a location reference.

The gNB, IAB donor, or CU may send user location related information to the AMF. The user location related information may include at least one of the following: cell identity (e.g., of the cell serving the IAB-MT), TAI, PLMN ID, TAC, cell information of the cell of a co-located DU. The cell information of the cell of the co-located DU may include at least one of: cell identity, TAI, PLMN ID, and TAC, among others. The AMF of the UE may then determine the UE's location according to the user location related information of IAB-MT and user location information of UE.

### J. Processes of Transferring Access-Related & Configuration Information in Integrated Access and Backhaul (IAB) Systems

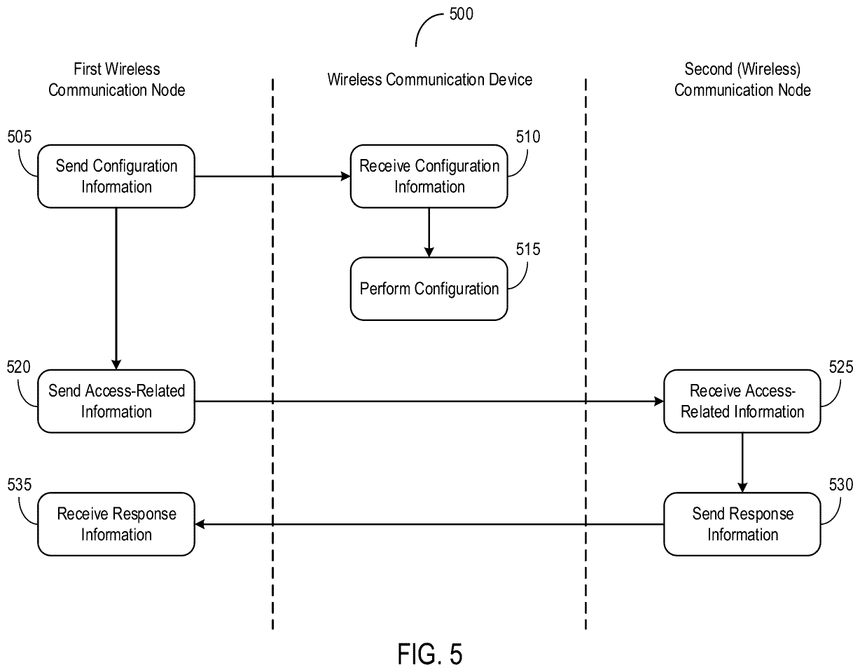

Referring now to FIG. 5, depicted is a flow diagram of a method 500 of transferring access-related and configuration information in integrated access and backhaul (IAB) systems. The method 500 may be implemented or performed using any of the components described above, such as the BS 102 or 202, UE 104, 204, 308a, or 308b, core network (CN) 302, and donor IAB 304, IAB node 306a-d, among others. In brief overview, a first wireless communication node may send configuration information (505). A wireless communication device may receive the configuration information (510). The wireless communication device may perform configuration (515). The first wireless communication node may send access-related information (520). A second wireless communication node may receive the access-related information (525). The second wireless communication node may send response information (530). The second wireless communication node may receive the response information (535).

In further detail, a first wireless communication node (e.g., a BS 102 or 202, CN 302, IAB node 306a-d) may provide, broadcast, transmit, or otherwise send configuration information to a network element, such as a wireless communication device (e.g., UE 104 or 204) (505). In some embodiments, the first wireless communication node may be arranged in accordance with split architecture, and may have a centralized unit (gNB-CU) and a distributed unit (gNB-DU). The configuration information may define, identify, or otherwise specify one or more parameters for facilitating communication with or access to a network cell (e.g., IAB cell) supported by at least one IAB node (e.g., a IAB node 306a-d, IAB-CU, or IAB-DU).

The configuration information may be for the wireless communication device to initialize and establish communications with the IAB node (e.g., a mobile IAB node or mobile relay (MR)) supporting the IAB cell. In some embodiments, the configuration information may identify or include one or more of: a mobile IAB indication, a mobile IAB prioritized indication, a mobile IAB-only indication, or an access-related identity, among others. The mobile IAB indication may specify that the identified IAB node is mobile. The mobility IAB priority (sometimes herein referred to as an MR-priority) may indicate that the recipient wireless communication device is to prioritize the cell for selection, re-selection, or handover, among others. The mobile IAB-only indication (sometimes herein referred to as MR-only indication) may specify that the recipient wireless communication device is to only permitted to access, select, re-select, or handover to cells of the IAB node.

In some embodiments, the access-related identity may identify or include one or more of: a vehicle identifier, vehicle name, a physical cell identifier (PCI), NR cell global identifier (NCGI), or Network Identifier (NID), among others. The vehicle identifier and name may correspond to a vehicle in which the mobile IAB node is situated or located. The PCI, NCGI, and NID may correspond to the cell network supported by the mobile IAB node. In some embodiments, the configuration information may identify or include one or more of: a closed access group (CAG) identifier, a human readable network name (HRNN), or a CAG-only indicator, among others. The CAG identifier may identify a set of wireless communication devices (e.g., UEs 104 or 204) permitted to access one or more cells associated with the CAG. The HRNN may identify the one or more cells associated with the CAG. The CAG-only indicator may specify that the wireless communication device is only allowed to access the one or more cells associated with the CAG.

In some embodiments, the configuration information may identify or include a mobility state information of the first wireless communication node. The mobility state information may indicate a degree of mobility of the first wireless communication node in the environment. The mobility state information of the first wireless communication node may be used to compare against the mobility state of the recipient wireless communication device to access, select, re-select, or handover in relation to cells. The mobility state may identify or indicate one of a low state, a medium state, or a high state. In some embodiments, the configuration information may identify or include a cell equivalent size (e.g., “cellEquivalentSize”) for a cell. The cell may be supported by the first wireless communication node or another node.

In some embodiments, the configuration information may include indications of change of a corresponding property from movement of the first wireless communication node (e.g., of the mobile IAB node). The configuration information may identify or include one or more of: a PCI change indication, a NCGI change indication, a frequency change indication, a tracking area code (TAC) change indication, a radio access network-based notification area code (RANAC) change indication, or a cell configuration change indication, among others. In some embodiments, the configuration information may identify or include one or more of: an old PCI, a new PCI, an old NCGI, a new NCGI, an old frequency, a new frequency, an old TAC, a new TAC, an old RANAC, or a new RANAC, among others.

The configuration information may specify conditions under which the wireless communication device is triggered to perform an intra/inter-frequency cell measurement. In some embodiments, the configuration information may identify or include one or more thresholds for triggering at least one intra/inter-frequency cell measurement. The thresholds (e.g., SIntraSearchP/SnonIntraSearchP and SIntraSearchQ/SnonIntraSearchQ) may be lower than previously set thresholds (e.g., SIntraSearchP/SnonIntraSearchP and SIntraSearchQ/SnonIntraSearchQ). In some embodiments, the configuration information may identify or include one or more of: a measurement time duration or a reference signal received power (RSRP) jitter threshold, among others. The measurement time duration and the RSRP jitter threshold may specify values at which to trigger the one intra/inter-frequency cell measurement.

In some embodiments, the first wireless communication node may receive at least one paging message from a second wireless communication node (e.g., from an access and mobility function (AMF)). The paging message may identify or include the configuration information. The configuration information of the paging message may identify or include one or more of: a mobile IAB indication, CAG ID, vehicle ID, NID, a list of identifiers identifying one or more cells which the UE is permitted to access, or an indication which indicates whether the UE is allowed to access non-mobile IAB cells, among others. Upon receipt, the first wireless communication node may send the configuration information of the paging information to the wireless communication device or a neighboring wireless communication node (e.g., gNB).

The wireless communication device may retrieve, identify, or otherwise receive the configuration information from the first wireless communication node (510). The configuration information received from the first wireless communication may include contents as discussed above. Upon receipt, the wireless communication device may parse the configuration information to extract or identify the contents therein. The wireless communication device may carry out perform configuration in accordance with the configuration information (515). Details of the performance of the configuration are described above in sub-sections A-I. In some embodiments, the wireless communication device may provide, transit, or otherwise send cell information to the first wireless communication node. The first wireless communication node may retrieve, identify, or otherwise receive cell information from the wireless communication device. The cell information may identify or include one or more of: a mobile IAB indication, a CAG identifier, a vehicle identifier, a NID of at least one cell.

The first wireless communication node may provide, transmit, or otherwise send access-related information to a second (wireless) communication node (e.g., a neighboring gNB, AMF, IAB donor, or gNB-CU) (520). The access-related information may be for the wireless communication device to communicate or access the cell supported by the mobile IAB node. In some embodiments, the access-related information may be retrieved, identified, or otherwise received from the wireless communication device. In some embodiments, the access-related information may be retrieved, identified, or otherwise received from an IAB node or a DU of a communication node (e.g., gNB-DU). The access-related information may identify or include one or more of: an on-board UE indication, a CAG identifier, a vehicle identifier, or a NID, among others.

Upon receipt, the first wireless communication node may send the access-related information to the second communication node. In some embodiments, a centralized unit (CU) connected with the first wireless communication node may send the access-related information to the second communication node. In some embodiments, the first wireless communication node or the CU may send the access-related information to the second wireless communication node or a CU connected with the second wireless communication node.

In some embodiments, the first wireless communication node (e.g., gNB or IAB node) may provide, transmit, or otherwise send user location related information to the second communication node (e.g., the AMF). In some embodiments, the CU connected with the first wireless communication node may send the user location related information to the second wireless communication node. The user location related information may identify or include one or more of: a cell identity, a tracking area identity (TAI), a public land mobile network (PLMN) identity, a tracking area code (TAC), or cell information of a cell of a co-located DU, among others. In some embodiments, the cell information of the cell of the co-located DU may identify or include one or more of: a second cell identity, a second TAI, a second PLMN ID, or a second TAC, among others.

The second (wireless) communication node may retrieve, identify, or otherwise receive the access-related information from the first wireless communication node (525). Upon receipt, the second communication node may parse the access-related information to identify or extract contents. The second (wireless) communication node may provide, transmit, or otherwise send response information to the first wireless communication node (530). In some embodiments, the response information may identify or include mobile restriction information. In response to the receipt of the access-related information, the second communication node may provide, transmit, or otherwise send the mobility restriction information. The mobility restriction information may identify or include one or more of: a mobile IAB prioritized indication, a mobile IAB indication, a MR indication, a CAG identifier, CAG only indication, a vehicle identifier, or a network identifier, among others. The second wireless communication node may retrieve, identify, or otherwise receive the response information from the second communication node (535). The second wireless communication node may parse the response information to extract or identify the contents.

### K. Processes of Facilitating Handovers in Integrated Access and Backhaul (IAB) Systems

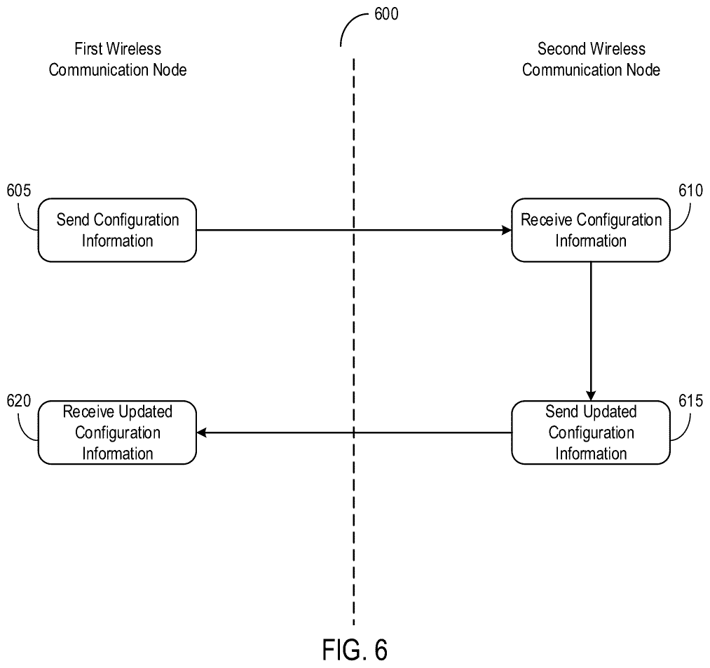

Referring now to FIG. 6, depicted is a flow diagram of a method 600 of facilitating handovers in integrated access and backhaul (IAB) systems. The method 600 may be implemented or performed using any of the components described above, such as the BS 102 or 202, UE 104, 204, 308a, or 308b, core network (CN) 302, and donor IAB 304, IAB node 306a-d, among others. In brief overview, a first wireless communication node may send configuration information (605). A second wireless communication node may the receive configuration information (610). The second wireless communication node may send updated configuration information (615). The first wireless communication node may receive the updated configuration information (620).

In further detail, a first wireless communication node (e.g., BS 102 or 202) may provide, transmit, or otherwise send configuration information to a network element, such as a wireless communication device (e.g., UE 104 or 204) or second wireless communication node (e.g., BS 102 or 202 or IAB node-MT) (505). In some embodiments, the first wireless communication node and the second wireless communication node each may be arranged in accordance with split architecture, and may have a centralized unit (gNB-CU) and a distributed unit (gNB-DU). The configuration information may be for a DU (e.g., gNB-DU), and may define, identify, or otherwise specify one or more parameters for facilitating communication with or access to a network cell (e.g., IAB cell) supported by at least one IAB node (e.g., a IAB node 306a-d, IAB-CU, or IAB-DU). In some embodiments, a CU connected with the first wireless communication node may send the configuration information to a CU connected with the second wireless communication node. The configuration information may identify or include one or more of: a PCI, a NCGI, or a TAC, or random access channel (RACH) configuration, among others. In some embodiments, the configuration information may identify or include a set of NCGIs to be added or released at the network element (E.g., IAB node). The set of NCGIs may be based on the number of requested NCGIs from the network element. In some embodiments, the network element (e.g., IAB node-MT) may provide, transmit, or otherwise send a number of requested NCGIs to the first wireless communication node.

The second wireless communication node may retrieve, identify, or otherwise receive the configuration information from the first wireless communication node or the CU connected with the first wireless communication node (610). In some embodiments, the CU connected with the second wireless communication node may retrieve, identify, or otherwise receive the configuration information from the first wireless communication or the CU connected with the first communication node. Upon receipt, the second wireless communication node may parse the configuration information to extract or identify contents therein. In some embodiments, the second wireless communication node may perform the configuration in accordance with the configuration information. Details of the performance of the configuration are described above in sub-sections A-I.

The second wireless communication node may provide, transmit, or otherwise send updated configuration information to the first wireless communication node or the CU connected with the first wireless communication node (615). In some embodiments, the CU connected with the second wireless communication node may provide, transmit, or otherwise send the updated configuration information to the first wireless communication node or the CU connected with the first wireless communication node. The updated configuration information may identify or include one or more of: an old PCI, a new PCI, an old NCGI, a new NCGI, an old TAC, a new TAC, random access channel (RACH) configuration, a timer, or a mobile IAB indication, or a mobile IAB cause value, among others. The first wireless communication node may retrieve, identify, or otherwise receive the updated configuration information from the first wireless communication node (620). Upon receipt, the first wireless communication node may parse the updated configuration information to extract or identify contents therein.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method of transferring information, comprising:
sending, by a first wireless communication node, configuration information to a network element,
wherein the network element is part of an integrated access and backhaul (IAB) system.

2. The method of claim 1, wherein the configuration information comprises at least one of: a mobile IAB indication, a mobile IAB prioritized indication, a mobile IAB-only indication, or an access related identity.

3. The method of claim 2, wherein the access related identity comprises at least one of: a vehicle identifier, vehicle name, a physical cell identifier (PCI), a NR cell global identifier (NCGI), or a Network Identifier (NID).

4. The method of claim 1, further comprising receiving, by the first wireless communication node, access-related information from a user equipment (UE).

5. The method of claim 4, wherein the access-related information comprises at least one of: an on-board UE indication, a closed access group (CAG) identifier, a vehicle identifier, or a Network Identifier (NID).

6. The method of claim 1, further comprising receiving, by the first wireless communication node or a centralized unit (CU) connected with the first wireless communication node, access related information from an IAB node or a distributed unit (DU), wherein the access related information comprises at least one of: a mobile IAB indication, a closed access group (CAG) identifier, a vehicle identifier, or a network identifier.

7. The method of claim 1, wherein the configuration information comprises at least one of: a physical cell identifier (PCI) change indication, a NR cell global identifier (NCGI) change indication, a frequency change indication, a tracking area code (TAC) change indication, a radio access network-based notification area code (RANAC) change indication, or a cell configuration change indication.

8. The method of claim 7, wherein the configuration information comprises at least one of: an old PCI, a new PCI, an old NCGI, a new NCGI, an old frequency, a new frequency, an old TAC, a new TAC, an old RANAC, or a new RANAC.

9. The method of claim 1, further comprising receiving, by the first wireless communication node from a UE, cell information comprising at least one of a mobile IAB indication, a closed access group (CAG) identifier, a vehicle identifier, a Network Identifier (NID) of at least one cell.

10. The method of claim 1, further comprising sending, by the first wireless communication node or a CU connected with the first wireless communication node, DU configuration information to a second wireless communication node or a CU connected with the second wireless communication node, wherein the DU configuration information comprises at least one of a physical cell identifier (PCI), a NR cell global identifier (NCGI), or a tracking area code (TAC), or random access channel (RACH) configuration.

11. The method of claim 10, wherein the second wireless communication node or the CU connected with the second wireless communication node sends updated DU configuration information to the first wireless communication node or the CU connected with the first wireless communication node.

12. The method of claim 11, wherein the updated DU configuration information includes at least one of: an old PCI, a new PCI, an old NCGI, a new NCGI, an old TAC, a new TAC, RACH configuration, a timer, or a mobile IAB indication, or a mobile IAB cause value.

13. The method of claim 1, further comprising sending, by the first wireless communication node or a CU connected with the first wireless communication node, to a communication node, user location related information.

14. The method of claim 13, wherein the user location related information comprises at least one of: a cell identity of a cell serving an IAB mobile termination (IAB-MT), a tracking area identity (TAI), a public land mobile network (PLMN) identity, a tracking area code (TAC), or cell information of a cell of co-located DU.

15. The method of claim 14, wherein the cell information further comprises at least one of a second cell identity, a second TAI, a second PLMN ID, or a second TAC.

16. A method information transfer, comprising:
receiving, by a network element, configuration information from a first wireless communication node,
wherein the network element is part of an integrated access and backhaul (IAB) system.

17. A network element, comprising:
at least one processor and a transmitter configured to:
receive configuration information from a first wireless communication node,
wherein the network element is part of an integrated access and backhaul (IAB) system.

18. A first wireless communication node, comprising:
at least one processor and a transmitter configured to:
send configuration information to a network element,
wherein the network element is part of an integrated access and backhaul (IAB) system.
